(19) United States
(12) Patent Application Publication
(10) Pub. No.: US 2006/0291637 A1
(43) Pub. Date: Dec. 28, 2006

(54) Systems and methods for a reliable teleconferencing system

(76) Inventor: David Erickson, Long Beach, CA (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 11/150,303

(22) Filed: Jun. 13, 2005

(51) Int. Cl. H04M 3/42

(52) U.S. Cl. 379/202.01

(57) ABSTRACT

The invention provides for systems that facilitate conference calls between a host and participants which comprises conferencing bridge units operably connected to the Public Switched Telephone Network and a communications system which can transfer information to an administrative operator, where the bridge units are located in more than one location. The invention also provides for a method to use the system to create a reliable reservationless conference call service.

### FIELD OF THE INVENTION

The present invention relates to systems for telephone conferencing and methods to use the system to achieve reliable on-demand conference calling.

### BACKGROUND

Corporations and individuals frequently encounter situations where a meeting between geographically separated parties would be appropriate, but the expenses associated with physical travel are prohibitive to that meeting taking place. In this situation, teleconferencing provides a convenient, low-cost solution by allowing individuals from various geographic locations to have a meeting over the telephone. Teleconferencing is also used within companies where parties to a meeting would not necessarily have to travel, but where meeting size exceeds available meeting space, or where gathering all meeting participants in one place is deemed inefficient. Private parties can also make use of teleconferencing for communicating simultaneously with multiple friends or family members over the phone.

In the past, teleconferencing was practiced from within a Private Branch Exchange (PBX) by manually dialing out to connect each participant to the others, with each participant placed on hold until all were connected to the conference originator. The disadvantages of this technique are many, with the most important being the continuing degradation in audio quality as each attendee is added, which often becomes unacceptable beyond three attendees. Additionally, this teleconferencing method is inconvenient and time-consuming. Further, many individuals and small business do not have the telephone equipment to teleconference in this manner.

Successor technology to PBX teleconferencing utilized conferencing bridge systems which used signal processing techniques to improve audio quality by controlling which talkers were summed together and provided to conference attendees as audio output of the bridge system. The primary disadvantage of this system is that the bridge system encompasses a limited number of voice channel resources, or ports, whose utilization must be manually monitored, scheduled, and controlled by an operator. This limitation requires users to schedule conferences in advance by specifying the time, duration, and number of ports required for the conference. What is needed is an automatic conferencing system or service that connects conferees together in teleconferences without a need for prior reservation or operator interaction.

While reservation-less conference call services exist, they are often unsatisfactory from the standpoint of the user because they are unreliable. The users of these services encounter a unacceptable number of busy signals when they attempt to complete their conference calls because the ports of the conferencing bridge are overwhelmed by a high number of calls.

Currently, conference call services that operate free of charge to their users generate their revenue by selling advertising space on their website or inserting advertisements into the messages played to users of the conference call service before they are put into their conference call rooms. These methods to generate revenue are inconvenient and often irritating to the user. They are also troublesome to the conference call service which must be continually soliciting new advertisers.

What is needed is a reservation-less conference call system which is reliable and results in few busy signals. In addition, a conference call system that can be run with no charge or inconvenience to the users.

### SUMMARY

The invention provides a system for a telephone conference calling service, as well as a method to use the system to achieve a reliable on-demand conference calling service.

The invention provides for systems that can be used to facilitate conference calls between a host and participants. The system may comprise a number of conferencing bridge units which may be operably connected to the Public Switched Telephone Service at more than one Local Exchange Carrier, as well as to a communication system, which may be connected to an administrative operator. The bridge unit may comprise one or more conferencing bridges, a hub, and a log server where the bridge units may be operably connected to the hub, and the log server may be operably connected to the hub, and the hub may be operably connected to the communication system. In some embodiments, the bridge unit may comprise a power back-up, a terminal server and/or a network security appliance. In other embodiments, the communication system may be the Internet.

In some embodiments, data on bridge usage may be collected and stored in a server, and more specifically, the log server of the bridge unit generating the data. In some embodiments, each log server may sent its collected data to at least one other log server, and may store data from at least one other log server via the communication system. In some embodiments, the data may be sent and received by the log server according to a schedule, on a daily basis, or about every 12 hours, about every 6 hours, about every one hour, about every 30 minutes, about every 5 minutes and about 1 minute.

In some embodiments, the administrative operator may be a server or a human.

In some embodiments, the LEC may be selected based on characteristics of a high termination fee, short length of time since FCC set termination fee, the high number of long distance carriers with lines into the LEC, the high number of lines into the LEC, relative underutilization of the LEC, high available capacity of the LEC, and favorable terms of contract with LEC. In other embodiments, the LEC may be selected based on the favorable contract terms of a high percent of termination fee, high ratio of lines into the LEC to lines into the bridge unit, high level of service and exclusivity.

The invention also provides for method to use the systems of the invention to create a reliable reservation-less conference call service. These methods may entail collecting data on the activity of each bridge unit, comparing the activity of each bridge unit based on the collected data, and assigning of new conference call numbers specific to bridge units and access codes to hosts based on one or more of the group consisting of optimization of reliability and optimization of profitability.

In some embodiments, the data collected may be the call-start time and date, call-end time and date, call-in number and participant/host origination number. In other embodiments, the data collected may be the start time/date of the call and the end time/date of the call.

In some embodiments, the activity of each bridge unit may be the percent total capacity usage of that bridge unit. In some specific embodiments, the percent total capacity usage for each bridge unit may be calculated by a mathematical equation. In other specific embodiments, the percent of total capacity usage (% C) of a bridge unit is calculated by the equation:

$$\% C = \frac{N * L}{P} .$$

where N is the number of calls per minute at peak usage of the bridge unit;

L is the average length of a call in minutes per day on the bridge unit; and

P is the number of ports operably connected to the PSTN on the bridge unit. In other specific embodiments, the percent total capacity usage of each bridge unit may be estimated by examining the data collected on the activity of each bridge.

In some embodiments, the methods of the invention may comprise compiling the data on activity on all of the bridge units. In some specific embodiments, the data may be compiled into a graphical depiction of the number of call-starts per time of day, more specifically the call-starts per time period of the day. In more specific embodiments, the time period depicted is about 30 minutes or the time period of the average call length.

In some embodiments, the data may be complied from all of the bridge units on a daily basis, or more often than on a than daily basis. In some embodiments, the data compiled may be call-starts per time of day, call-ends per time of day, total minutes of calls per day, total number of calls per day and average length of a call per day, more specifically, calls started per time of day. In some embodiments, the data is compiled on time increment of about 30 minutes.

In some embodiments, the collecting step, the comparing step and the assigning step are all done by computer, optionally more than one computer.

In some embodiments, the new call-in numbers may be assigned by balancing the factors of percent total capacity usage of bridge unit, available capacity at the LEC housing the bridge unit, and quality of service at the LEC housing the bridge unit. In other embodiments, the new call-in numbers may be assigned by balancing the factors of termination fee set by the FCC at the LEC housing each bridge unit, percent termination fee negotiated with the LEC housing each bridge unit and expiration date of contract at the LEC housing each bridge unit.

In some embodiments, the new call-in numbers may be assigned by allocating to each bridge unit a specific percentage of the new hosts by assigning to the hosts call-in numbers specific to a particular bridge unit. In specific embodiments, this new call-in numbers are assigned through a website, more specifically a website that is self-service on the part of the customer.

In some embodiments, the call-in number and access code have a finite lifetime of host use. In specific embodiments, the call-in number and access code lifetime may be set to a time period by balancing the need to adjust the percent total hosts allocated to each bridge unit and the host satisfaction with the system. In other specific embodiments, the lifetime of the call-in number and access code may be at least about 30 days, at least about 60 days, at least about 90 days or at least about 120 days.

These and other aspects, advantages, and features of the invention will become apparent from the following figures and detailed description of the specific embodiments.

### BRIEF DESCRIPTION OF THE FIGURES

FIG. 1 is a diagram of one embodiment of the conference call system.

FIG. 2 is an example of data gathered by a bridge unit 80 over a day displayed in a manner that facilitates the estimation of the percent maximum capacity usage of the bridge unit 80. The x-axis of this bar graph consists of the day divided into 30 minute time periods. The y-axis consists of the number of call starts on the bridge unit 80 within the 30 minute time periods specific by the x-axis, where the maximum value is 672, the number of ports per the particular bridge unit 80.

### DETAILED DESCRIPTION OF THE EMBODIMENTS

Definitions

As used herein, the term “local exchange carrier” (LEC) refers to the local or regional telephone company that owns and operates lines to customer locations.

As used herein, the term “public switched telephone network” (PSTN) refers to non-dedicated local access between the customer's premise and the serving wire center which is interconnected to the company's point-of-presence for origination or termination of service.

As used herein, the term “termination fees” refer to fees paid by the Interexchange Carriers to Local Exchange Carriers to terminate a call in that exchange.

As used herein, the “host” is a person or entity who receives a call-in number and access code from the conference call service. The host may distribute the call-in number to the participants of the conference call, along with the time and date of the conference call. Alternatively, the conference call service may distribute the call-in number and access code to participants designated by the host.

As used herein, the term “participant” is a person or entity that receives a call-in number and access code and uses them to participate in a conference call.

As used herein, the term “call-in number” means a telephone number that will connect the caller to a bridge unit of the system. The call-in number is assigned to a host by the conference call service, along with an access code. The call-in number may have a finite lifespan.

As used herein, the term “access code” means a series of numbers and/or letters that designates a “conference room.” After the host or participant dial the call-in number and connect to a bridge unit of the system, the they are prompted to enter the access code. The conferencing bridge of the bridge unit then places callers entering the same access code into the same “conference room.”

As used herein, the term “lifespan” means the temporal period which an newly issued call-in number and access code are considered to be active. The host is informed of the lifespan of the call-in number and access code at the time these items are issued to him by the conference call service. After the lifespan of the call-in number and access code have “expired”, the host is to cease using them an contact the conference call service for a new call-in number.

General

The present invention provides systems for conference calling and a methods that utilizes the systems of the present invention to achieve reliable, on-demand conference calling. In one embodiment, the system uses more than one bridge unit which can be located in one or many locations. A call-in number and an access code are assigned to users on request, with each assignment having a specified lifespan. Each call-in number is specific to a bridge unit. The call-in numbers are assigned to hosts based on the usage of each of the bridges at the time the user requests a call-in number, in order to distribute the calls over the system of bridge units. Along with the call-in number, the user is also assigned an access code. To plan a conference call, the user distributes the call-in number and the access code to each of the conference call participants, along with the date and time of the conference call. At the appropriate time, the host and each participate dials the call-in number, enters the access code, and is placed by the bridge unit specific to the call-in number into a single conference “room” based on the access code. To terminate the conference call, each caller hangs up. The call-in number and access code can be used as many times and for an unlimited number of minutes until the call-in number/access code reaches the end of its lifespan and expires. When the call-in number/access code expires, the host may contact the conference call service for a new call-in number and access code.

The Conference Call System

The system facilitates a conference call between a host and a number of participants, and may be comprised of more than one bridge unit containing conferencing bridges placed at more than one Local Exchange Carrier (LEC). The bridge units may interface with the Public Switched Telephone Network (PSTN) through ports, as well as with a communications system. A bridge unit may gather information on the number of calls into the bridge unit and may store it for later communication to an administrative operator via a communications system.

One advantage of the system is the possibility of placing bridges in different LEC's, and easily adding and/or removing bridges from the system to compensate for increased or decreased usage, including putting more than one conferencing bridge at a specific site. Therefore, the system is very flexible and can be easily up-scaled or rearranged to restructure the system to conform with current usage demands.

Another advantage of the multi-site bridge unit placement is that the bridge units may be placed in locations where the characteristics of the LEC are particularly favorable, and bridge units may be removed from an LEC when the characteristics become unfavorable. Favorable characteristics may pertain to the quality of service offered by the LEC, the number of lines available, the number of long-distance carriers that have lines connected to the LEC, and the amount of capacity available at the LEC.

Another advantage of the multi-bridge unit system is that bridge units may be placed so as to create a source of revenue of the conference call service. Local exchange carriers receive a termination fee from the FCC for each call terminated in their area code. The conference call service may enter into contracts with a LEC in which, in exchange for placing a bridge unit in their exchange, the LEC agrees to pass on a percentage of the termination fee for each call terminated at that bridge unit to the conference call service. Locations of bridges may be chosen based on the terms of the contracts made with the LEC. These contracts may therefore yield an additional source of revenue for the conference call service. The flexibility of the system is key to remodeling the system to take advantage of newly contracted LEC's, and phase-out of LEC with relatively unfavorable or expiring contracts. The more favorable contract may include one or more of the following: relatively high termination fees, a higher percentage of termination fee; exclusivity of conference call service at that location, lower minimum minutes, higher maximum minutes and longer length of contract.

The invention provides for systems for a conference call service to facilitate conference calls between a host and more than one participant, and which may be operated by an administrative operator. The system includes more than one bridge unit, which may be housed at a central office of more than one LEC, and which may connect to the Public Switched Telephone Network (PSTN) and to a communications network. In this embodiment of the system, all of the bridge units may be connected to the same communications network, and so can communicate with each other as well as with the administrative operator, who also can access the communications network. In a specific embodiment, the communications network may be the Internet.

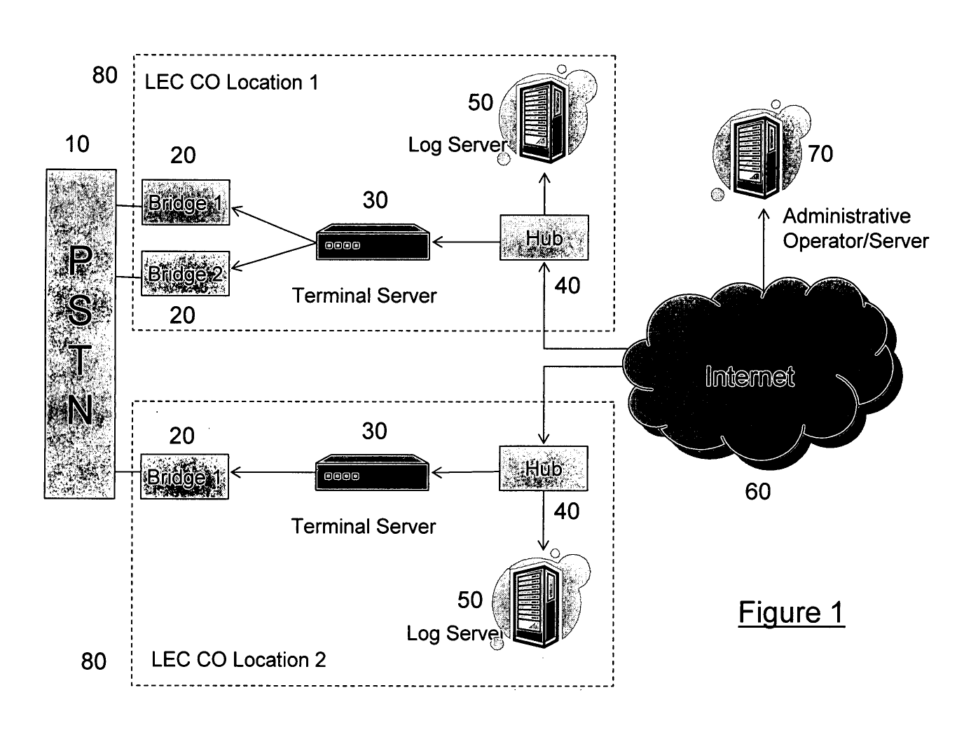

In one embodiment of the present invention, and with reference to FIG. 1, the bridge units 80 of the invention may include one or more conferencing bridges 20, optionally a terminal server 30, a hub 40, a log server 50, and optionally, a power supply and/or a network security appliance. The conferencing bridge(s) 20 may be operably connected to the PSTN 10 by three or more ports, and to the terminal server 30, the terminal server 30 may be operably connected to a hub 40, and the hub 40 may be operably connected to the log server 50. In one embodiment, the hub 40 may be operably connected to the Internet 60. In another embodiment, the hub 40 may be operably connected to an network security appliance, which is in turn may be operably connected to the Internet 60. Additional bridges 20 may be added to the bridge unit 80 by operably connecting the additional bridge 20 to the PSTN and to the terminal server 30.

The conferencing bridges 20, and other components of the bridge units 80, may be rented or purchased from several commercial suppliers. Conferencing bridges 20 that may be used in making the bridge units 80 of the invention include, but are not limited to, the VSR 1000-8T model ThinkEngine® Conferencing Bridge (ThinkEngine Networks, Inc., Marlborough, Mass.), and Vapps® Conferencing Bridge (Vapps, Hoboken, N.J.). Hubs 40 that may be useful in making the bridge units 80 of the invention include, but are not limited to, the SuperStack® II Hub 1000 (3Com, Marlborough, Mass.). Terminal servers that may be useful for making the bridge units 80 of the invention include, but are not limited to, the 8-port console switch-terminal server with remote access (Western Telematic, Inc., Irvine Calif.). Servers that may be useful for making the bridge units 80 of the invention include, but are not limited to, an Intel Pentium® 4 2.4 GHz CPU 533 MHz, with 512 mb memory, a 80 GB 7200 RPM hard drive, running a Windows 2000 operating system. Optionally, the bridge unit 80 may contain a network security appliance, such as the CyberGuard® SG530 2-port firewall/VPN (Cyberguard, Deerfield Beach, Fla.). These components are described only to illustrate the system, and are not meant to limit it.

In a specific embodiment, as the conferencing bridge 20 may receive incoming calls from the PSTN and may place the callers into a “conference room,” data on the call, such as the time/date that the call started and ended and the call-in number used, may be logged in the long server of the bridge unit 80. Periodically, the logged data may be collected and may be used to determine the amount of conferencing bridge 20 capacity that is being used throughout the day. The conferencing bridges 20 may be operably connected to the PSTN through the standard equipment, such as a 4ESS/5ESS/Softswitch. The call-in data may be transferred via operable connections through the terminal server 30, then through the hub 40 to the log server 50. The log server 50 may then store data originating from the conferencing bridge 20 on the hard drive. Software may be run on the log server 50 that sorts the data put out by the conferencing bridge 20 into a format that is easier to read, and this software can be easily developed by one of skill in the art. The log server 50 also may run software that operates the conferencing bridge(s) 20. The terminal server may be used for remotely access to the system to reset it or view the systems.

The communication system may utilize any appropriate methods by which the data collected and saved on the log server 50 can be transmitted to the administrative operator. This system may be as simple as a local human administrator accessing the data on the bridge unit 80 and communicating the data to the administrative operator by a telephone call or facsimile message. Other appropriate communication systems will be well known to those skilled in the art. In some embodiments, the hub 40 may operably connected to the Internet 60, and the Internet 60 may the communication system. This connection may be a broadband, narrow band or dial-up connection. Appropriate software and hardware to establish and run this Internet 60 connection may included in the bridge unit 80, as will be well known to those skilled in the art. In some embodiments, the Internet 60 connection may be conducted through a network security appliance which prevents unauthorized access to the log server 50.

In some embodiments, the log servers 50 of the bridge unit 80s in the system may communicate to each other via the communications system. In a specific embodiment, the log servers 50 may communicate to each other via the Internet 60. The intercommunication of the log servers 50 may be carried out using standard Internet protocols, as will be well known to those skilled in the art. In another specific embodiment, the log servers 50 in the system may back-up the data of the other log servers 50 by exchanging and storing their data with the other log servers 50. Each log server 50 may send its collected data to at least one other log server 50 in the system, and each log server 50 may store the data from at least one other log server 50 in the system. In a specific embodiment, each log server 50 may send its data to every other log server 50 in the system, and may receive and store data sent by every other log server 50 in the system. It is advantageous that this exchange of data occur on a periodic basis, and particularly at a fixed time. In other specific embodiments, the data may be sent and received by the log servers 50 on a predetermined schedule, or on a daily basis. For example, all of the log servers 50 of the system may be programmed to send their data via the Internet 60 to all of the other log servers 50 in the system, and may receive data via the Internet 60 and store the data from the other log servers 50 of the system at midnight every day. In other embodiments, the data may be sent and received by the log servers 50 on a periodic basis, from about 1 minute to about 1 month. In specific embodiments, the data may be sent and received by the log servers 50 at a time interval of about 24 hours, about 12 hours, about 6 hours, about one hour, about 30 minutes, about 5 minutes or about 1 minute.

The administrative operator of the system receives that data collected by the bridge units 80 via the communication system. The administrative operator may be a server or a human. In some embodiments, the administrative operator may be a human who receives the data from the bridge units 80 by a telephone call from a human operator locally accessing the log servers 50 of the bridge units 80. In other embodiments, the administrative operator may comprise a server operably connected to the Internet 60, which may receive and save the data from the bridge units 80, optionally at the same time as the log servers 50 are backing up their stored data on the other log servers 50.

The bridge units 80 of the system may be placed at more than one LEC operably linked to the PSTN. The LECs may be selected based on the characteristics of the LEC, as well as the terms of any contracts negotiated with the LEC. Favorable LEC characteristics may include, but are not limited to, a high number of long distance carriers with lines into the LEC, high number total number of lines into the LEC, the relative underutilization of the LEC, and a high available capacity at the LEC. Important characteristics may focus on the capacity of the LEC to handle a high volume of new calls, the quality of connectivity the LEC has with the long distance carriers, and aspects that lead to a high termination fee from the Federal Communications Commission (FCC) for calls terminating in the LEC. The available capacity of the LEC may depend on the number of lines into the LEC, as well as the existing use of those lines, among other things. The quality of the connectivity of the LEC may include the number of long distance carriers that support lines into the LEC.

In some embodiments, the bridge units 80 may be located at a LEC based in part on the termination fee that the LEC receives from the FCC, including factors such as a high termination fee and favorable contract terms with the LEC. The FCC may collects fees from long distance carriers which it distributes to LECs for calls originating and terminating in their exchange. The “termination fee” may be set by the FCC based on characteristics of the LEC, such as amount of copper wiring that the LEC must maintain, the number of subscribers in the exchange, and the number of calls originating and terminating in the LEC. The conference call service may negotiate a contract with the LEC where the conference call service agrees to place and operate a bridge unit 80 at the central office of the LEC in exchange for a percentage of the termination fee received by the LEC for each call terminating at the bridge unit 80. Therefore, characteristics of the LEC that may lead the FCC to set a higher termination fee may make the LEC a more desirable location for a bridge unit 80. Such factors include a large amount of copper wiring to maintain, a low number of subscribers and a low number of calls originating from, and terminating in, the exchange. In addition, a contract between the conference call service and the LEC that is particularly favorable for the conference call service may also make that LEC a desirable location for a bridge unit 80. Favorable contract terms may include higher percentage of termination fee, at least a 1:1 ratio of lines connecting the LEC to the PSTN to lines connecting the LEC to the conferencing bridges, high level of service and exclusivity of the conference call service in that LEC. A high level of service may be comprised of factors such as access to the PSTN without complications, quality of connection, and continual availability of free lines into the LEC from the PSTN.

Method to Use the Conference Call System

Another aspect of the invention is a method that may utilize the conference call system to facilitate reservation-less conference calls with high reliability and profitability. The method may continually monitors the usage of the bridge units 80 in the system, and may adjust the distribution of conference calls over the system by issuing new call-in numbers specific to under-utilized bridge units 80. By continually balancing the flow of calls into the system over the bridge units 80, over-loading of bridge units 80 may be prevented and the reliability of the service hence improved. The methods may also optionally maximize the revenue received by the conference call service operating the system by directing new hosts to the bridge units 80 in LECs with higher revenue contracts by issuing new call-in numbers specific to the bridge units 80 in those LECs.

One feature of the methods of the present invention is its ability to create a reliable reservation-less, on-demand conference call system. Upon registration, the host may receive a call-in number specific to a bridge unit 80 and an access code that may be used at any time during the lifespan of the call-in number and access code. This feature may allow the host to set conference calls in advance and also at the spur of the moment, without making a reservation with the conference call service beforehand. It may be convenient for the host because unlimited conference calls can be made using one call-in number and access code until they expire, saving the host from laboriously notifying the participants of a new call-in number and access code for every new conference call.

Another feature of the method of the invention is that each call-in number/access code may be assigned a finite lifespan. A certain degree of turn-over of call-in numbers may be desirable as it allows the assignment of new call-in numbers that may reflect an updated view of the system usage. For example, if bridge unit #3 is approaching its maximum capacity of calls, and bridge unit #2 has capacity not being used, then more of the new call-in numbers will be specific to bridge unit #2 than bridge unit #3. Thus, the turnover created by the finite lifespan of the call-in number/access code may be one way of keeping the usage of the system in balance without reservations, and to maintain a high degree of reliability.

Another feature of the method is the use of the system in a manner that maximizes the revenue of the conference call service. The bridge units 80 may be placed in LEC where the conference call service has entered into contracts for a percentage of the termination fee. Therefore, the assignment of new call-in numbers may be maximize the revenue of the conference call service by directing system usage to bridge units 80 that yield the highest revenues.

In a specific embodiment, the methods of the present invention may comprise: collecting data on the activity of each bridge unit 80; comparing the activity of each bridge unit 80 based on the collected data; and assigning new call-in numbers specific to bridge units 80 and access codes to hosts in a manner that will optimize the reliability of the system and/or the profitability of the system. The method optionally may comprise an additional step of compiling the data on the activity of all of the bridge units 80.

At each bridge unit 80, data may be collected throughout the day on the flow of calls through that bridge unit 80. For example, the time/date that each caller starts an individual call and the time/date that the caller ends the call. Other data collected at each bridge unit 80 may include, but is not limited to, the call-in number of each call, the host/participant phone number of origination of each call. In a specific embodiment, the data collected may be the start time/date of the call and the end time/date of the call. As this data may be collected in each bridge unit 80, it may be stored on the log server 50 of the bridge unit 80.

The data collected by each of the bridge units 80 may be compared so as to determine the relative capacity for calls available at each of the bridge units 80, or percent total capacity usage of the bridge unit 80. The relative capacity for calls may be generally the number of open ports to the PSTN on the conferencing bridge 20 during peak usage. This comparison may be done conveniently by calculating the percent total capacity usage for each bridge unit 80, and then comparing these values. This “calculation” may be done by using an equation, or simply by an operator looking over the compiled data and making a general judgment based on it. It may be most advantageous to gauge the percent total capacity usage at the time of peak activity during the day.

An estimate of the percent total capacity usage of each bridge unit 80 may be made using the equation 1:

$$\% C = \frac{N * L}{P}$$

where N is the number of calls per minute at peak usage;

L is the average length of a call per day

P is the number of PSTN ports on the bridge unit 80

In one specific embodiment, percent total capacity use may be calculated for each bridge unit 80 using a computer program. In some embodiments, the calculation may be made by the log server 50 and in other embodiments, the calculation may be made by the administrative server 70.

In another specific embodiment, the comparing step and the assigning step, and optionally the compiling step, may be done via computer program(s). In some embodiments, these steps may be performed by one computer, optionally the administrative server 70. In other embodiments, these step may be performed by more than one computer, optionally the log server 50 and/or the administrative server 70. For example, a computer program or programs may calculate the percent total capacity use of each of the bridge units 80, and the percent total capacity use for the entire conference call system, compared the percent total capacity of each of the bridge units 80 to that of the percent total capacity use for the entire conference call system, and assign new call-in numbers by taking call-in numbers off of the assignment list when the percent total capacity use of the bridge units 80 that they are specific to exceeds the percent total capacity use of the entire system. In some embodiments, the computer performing all or some of the steps of the method may also be the computer running the website.

Alternatively, the percent total capacity usage of each bridge unit 80 may be estimated by examining the data collected by each bridge unit 80. For example, by generally comparing the frequency of calls into the bridge unit 80 over the course of the day with the number of ports available for these calls on that bridge unit 80, a general idea of the percent total capacity usage of that bridge unit 80 may be determined. A more specific idea of the percent total capacity usage of a bridge unit 80 may be determined by taking into account the average length of a call at that bridge unit 80 along with the frequency of the calls.

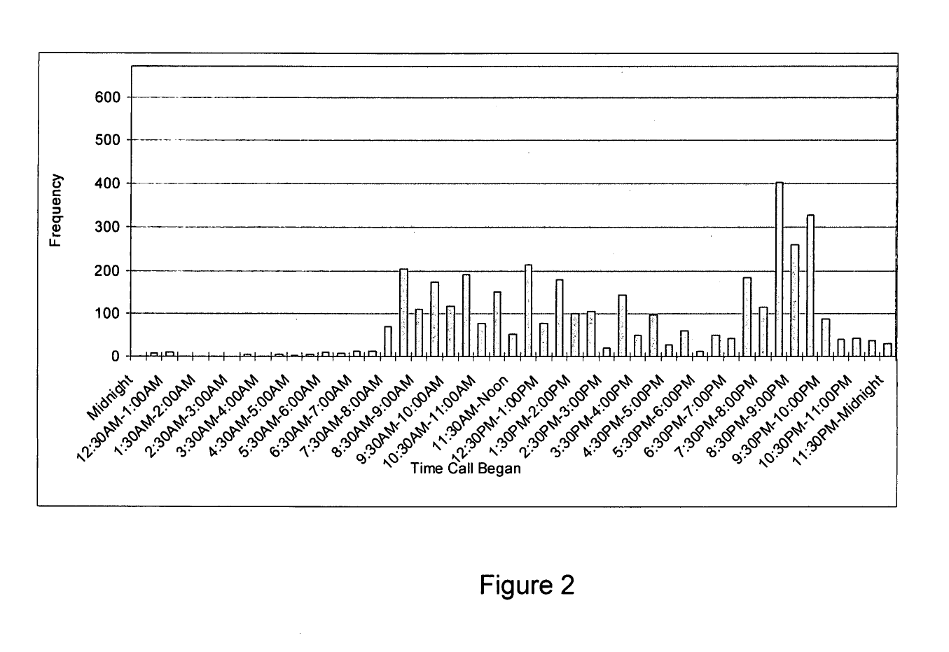

When estimating the percent total capacity usage for each bridge unit 80 without making calculations, a graphical display of the data may be useful. Referring to FIG. 2, one such graphical display may be a bar graph with the period of the day on the x-axis, and the calls into the bridge unit 80 per that period of time on the y-axis. This format may be particularly advantageous if the time period chosen to display the data is equal to the average length of call. For example, if the average length of a call is 30 minutes, then the data of the frequency of call starts over the day is broken down into 30 minute time periods for each bridge unit 80. When displayed in this manner, the calls in for that period may be roughly equal to the ports occupied during that period, and thus the height of the bar may be directly compared to the number of ports available on that bridge unit 80 to quickly estimate the percent total capacity usage.

In another embodiment, the occupancy of the ports on the bridge unit 80 may be monitored directly throughout the day, and the percent of occupied ports is recorded. In this embodiment, the percent of occupied ports may be the percent total capacity usage for that bridge unit 80.

In a more specific embodiment, the methods of the present invention may comprise the additional step of compiling the data on the activity of the bridge units 80 into a format convenient for determining the percent total capacity usage for each of the bridge units 80 and comparing with data between bridges 20. Compiling of data may be particularly advantageous when using graphical displays of data as the data for all of the bridge units 80 can be inspected and compared simultaneously. In one specific format, the compiled data may be broken down into time periods of the day, for example, hourly, every 30 minutes, or less than every 30 minutes, or every minute. The time period may be most advantageously one that will give an accurate view of the number of calls being serviced by each bridge unit 80 at the time of the day of the peak usage. It may be also advantageous to display the compiled data in a graphical format to facilitate inspection. Finally, the data compiled may specifically be data that will be useful in determining the relative usage of each of the bridge units 80. Data of specific interest may include, but are not limited to, number of calls started per time period, number of calls ended per time period, and distribution of call lengths. In one specific embodiment, the compiled data may be presented in graphical depiction of the frequency of call starts over the day broken down into 30 minute time periods. In another specific embodiment, the compiled data may be presented in a graphical depiction of the frequency of call starts over the day broken down into one minute time periods.

This compilation may be done on a regular basis, specifically daily, hourly or every 30 minutes, depending on the need for updated information. The compilation may be accomplished in some embodiments by using the communication system that is operably connected to the bridge unit 80 to transfer the data to a central location. This compilation may be optionally accomplished by using the Internet 60 connection of the bridge unit 80 to transfer the data collected in each bridge unit 80 to a administrative operator, also connected the Internet 60, where the collected data is compiled into a form that allows the usage of each of the bridge units 80 to be compared.

A related aspect of this step may be the option to have the bridge units 80 exchange their collected data on a regular basis. In this manner the data from each bridge unit 80 may be backed up on each of the other bridge units 80 as a precaution, and also to compile it. In specific embodiments, the data from the bridge units 80 may be backed-up on the other bridge units 80, and optionally, on an administrative operator that is a server. The timing of the back-up procedure may be ideally done periodically, at a period length from one minute to one month. In specific embodiments, the period length may be one hour, 12 hours, 24 hours and 2 days, among others. It may be advantageous for the bridge unit 80 usage data to be backed-up on an administrative operator/server in order for the data to be easily compiled into a form for comparing the relative usage of each of the bridge units 80. In a specific embodiment, the usage data from one bridge unit 80 may be backed-up on every other bridge unit 80 log server 50 in the system as well as the administrative operator/server, at a period length of 24 hours.

Another step in the methods of the present invention comprises assigning to hosts new call-in numbers specific to bridge units 80 based on a series of factors that may be relevant to optimization of the reliability and profitability of the conference call service. Alternatively, this step of the method may be carried out by placing the emphasis on the reliability of the service, and deprioritizing the profitability, or, conversely, placing the emphasis on the profitability of the service and deprioritizing the reliability. Alternatively, the reliability and profitability factors may be given different weights at different bridge units 80, for example, by de-emphasizing reliability at a bridge unit 80 where there are particularly favorable contract terms with the LEC by allowing the percent total capacity usage to rise to a higher level on that bridge unit 80.

In the assigning step, the reliability of service may include, but is not limited to, the percent total capacity usage of each bridge unit 80, the number of lines available into the LEC hosting the bridge unit 80, and quality of service at the LEC housing the bridge unit 80. The reliability of the conference call service may fail primarily when the number of callers to a bridge unit 80 exceeds the number of ports available on that bridge unit 80, resulting in the caller getting a busy signal. Therefore the reliability may be increased when the percent of total capacity usage of the bridge units 80 is lower. However, if the percent of total capacity usage may be too low, then the resources of the bridge units 80 are not being used efficiently. In some embodiments, the maximum percent total capacity usage tolerated may be between about 50% and about 95%. In specific embodiments, the maximum percent total capacity usage tolerated may be about 60%, about 70%, about 80% or about 90%. In a most specific embodiment, the maximum percent total capacity usage tolerated per bridge unit 80 may be about 80%.

The revenue source that can be manipulated by the assignment of call-in numbers may be revenue that originates from the termination fees awarded to the LEC. The profitability of the service may be therefore determined by a number of factors, including but not limited to, the termination fee set by the FCC for the LEC housing the bridge unit 80, the percent of the termination fee in the contract negotiated with the LEC, and the expiration date of the contract with the LEC housing the bridge unit 80. In addition, a contact between the conference call service and the LEC may include a minimum number of minutes of calls that must be provided to the LEC in order for the conference call service to keep its exclusivity. The fulfillment of this minimum number of calls may also be a consideration when assigning new call-in numbers.

Each bridge unit 80 may have more that one call-in number assigned to it. Multiple call-in numbers may be used to advantage in some embodiments by allowing the conference call service to follow the usage of particular hosts. For example, if a particular call-in number is assigned to only to one host, such as a corporate client, the conference call service can provide that host with a detailed report of how the conference call service was used by that host, including but not limited to, the telephone numbers of originating calls, the time/ day and length of each conference call, and the number of participants in each conference call. Different phone numbers may be assigned to track the usage of particular kinds of hosts, for example hosts who obtained the call-in number and access code from a website or advertisement in a foreign language. Assigning specific call-in numbers to hosts in different time zones may be advantageous to tracking the peak use of the bridges units 80 from these time zones, and balancing the usage over the system on a 24 hour a day basis.

An important feature of the call-in number and access code may be their, finite lifespan. The limited lifespan of the call-in number and access code may be a factor leading to reliability of the conference call service as a short life span may allow the redistribution of the calls to the individual bridge units 80 to be made more frequently, and thus there is less risk at running the bridge units 80 at a higher percents of total capacity usage. The enforcement of this lifespan may be left to the honor of the host, or affirmatively achieved by, for example, the blocking and/or removing the telephone number and/or access codes from the system. The lifespan of the call-in number/access code may be optimally short enough to ensure that the usage of the system can be kept in balance by allocation of new call-in numbers, yet not so short that the host becomes inconvenienced by not being able to plan conference calls in advance and by frequent redistribution of call-in numbers and access codes to participants. The lifespan of the call-in number/access code may be different for different classes of hosts. The lifespan may also be infinite, but able to be terminated upon the decision of the conference call service. For example, a preferred corporate host may be given an call-in number/access code with an infinite lifespan which can be terminated upon notice if the bridge unit 80 that it is specific to is removed from the system or over its optimum percent total capacity usage. The lifespan of the call-in number/access code may be any period. In some embodiments, it may be set anywhere from 1 minute to 1 year. In specific embodiments, the lifespan of the call-in number/access code may be at least about 30 days, at least about 60 days, at least about 90 days, or at least about 120 days.

In another embodiment, the call-in numbers and access codes may be issued to hosts through website. The website may be optionally run by the conference call service. In one embodiment, the website may be self-serve on the part of the host, who is able to receive a call-in number and access code upon request. There may also be several websites in different languages in order to recruit hosts from different time zones and assign them call-in numbers in order to spread the usage of the system over a 24 hour period.

1. A system for facilitating conference calls between a host and a plurality of participants, which is controlled by a administrative operator, comprising:
a Public Switched Telephone Network (PSTN);
a plurality of bridge units connected to the PSTN at more than one Local Exchange Carrier (LEC); and
a communications system which connects the bridge units to the administrative operator;
wherein the system facilitates a conference call between the host and the plurality of participants.

2. The system of claim 1 wherein the bridge unit further comprises:
one or more conferencing bridges;
a hub; and
a log server; wherein,
each conferencing bridge is operably connected to the PSTN by three or more ports and to the hub;
the hub is operably connected to a log server; and
the hub is operably connected to the communications system.

3. The system of claim 2, wherein the bridge unit comprises at least one component selected from the group consisting of a power backup unit, a terminal server and a network security appliance.

4. The system of claim 1 wherein the communications system is the Internet.

5. The system of claim 2 wherein data on bridge unit usage is collected and stored in a server.

6. The system of claim 5, wherein the data is stored in the log server that is a part of the bridge unit generating the data.

7. The system of claim 6 wherein each log server sends its collected data to at least one other log server, and receives and stores data from at least one of the other log servers via the communication system.

8. The system of claim 7 wherein the data is sent and received by the log servers according to a schedule.

9. The system of claim 8, wherein the data is sent and received on a daily basis.

10. The system of claim 8, wherein the data is sent and received at a time interval selected from the group consisting of about 12 hours, about 6 hours, about one hour, about 30 minutes, about 5 minutes, and about 1 minute.

11. The system of claim 1 wherein the administrative operator is selected from one or more of the group consisting of a human and a computer.

12. The system of claim 1, wherein the LECs are selected based on a group of characteristics consisting of a high termination fee, short length of time since FCC set termination fee, the high number of long distance carriers with lines into the LEC, the high number of lines into the LEC, relative underutilization of the LEC, high available capacity of the LEC, and favorable terms of contract with LEC.

13. The system of claim 12, wherein the favorable terms of contract with LEC are a high percent of termination fee, high ratio of lines into the LEC to lines into the bridge unit, high level of service and exclusivity.

14. A method to use the system of claim 1 comprising the steps of:
(a) collecting data on the activity of each bridge unit;
(b) comparing the activity of each bridge unit based on the collected data; and
(c) assigning of new conference call numbers specific to bridge units and access codes to hosts based on one or more of the group consisting of optimization of reliability and optimization of profitability.

15. The method of claim 14, wherein the data collected in said collecting step is selected from one or more of the group consisting of call-start time and date, call-end time and date, call-in number and participant/host origination number.

16. The method of claim 15, wherein the data collected in said collecting step is the start time/date of the call and the end time/date of the call.

17. The method of claim 14, wherein the activity of each bridge unit is the percent total capacity usage of that bridge unit.

18. The method of claim 14, wherein the percent total capacity usage for each bridge unit is calculated by a mathematical equation.

19. The method of claim 14 wherein the percent of total capacity usage (% C) of a bridge unit is calculated by the equation:
$$\% C = \frac{N * L}{P} .$$
where N is the number of calls per minute at peak usage of the bridge unit;
L is the average length of a call in minutes per day on the bridge unit; and
P is the number of ports operably connected to the PSTN on the bridge unit.

20. The method of claim 14, wherein the percent total capacity usage of each bridge unit is estimated by examining the data collected on the activity of each bridge.

21. The method of claim 20, which comprises the additional step of
(d) compiling the data on activity on all of the bridge units.

22. The method of claim 21, wherein data is compiled into a graphical depiction of the number of call-starts per time of day.

23. The method of claim 22, wherein the graphical depiction displays the call-starts per time period of the day.

24. The method of claim 23, wherein the time period is about 30 minutes.

25. The method of claim 23, wherein the time period is about the time period of the average call length.

26. The method of claim 21, wherein the data in said compiling step is complied from all of the bridge units on a daily basis.

27. The method of claim 26, wherein the data in said compiling step is compiled more often than on a than daily basis.

28. The method of claim 21, wherein the data in said compiling step complied is data selected from the group consisting of call-starts per time of day, call-ends per time of day, total minutes of calls per day, total number of calls per day and average length of a call per day.

29. The method of claim 28, wherein the data compiled in said compiling step is data from the group consisting of calls started per time of day.

30. The method of claim 21, wherein the data in said compiling step compiled is compiled on time increment of about 30 minutes.

31. The method of claim 21, where in the collecting step, comparing step and assigning step are all done by at least one computer.

32. The method of claim 14, wherein the reliability of service in said assigning step is optimized by balancing one or more of a series of factors consisting of percent total capacity usage of bridge unit, available capacity at the LEC housing the bridge unit, and quality of service at the LEC housing the bridge unit.

33. The method of claim 14, wherein the profitability of service in said assigning step is optimized by balancing one or more of a series of factors selected from the group consisting of termination fee set by the FCC at the LEC housing each bridge unit, percent termination fee negotiated with the LEC housing each bridge unit and expiration date of contract at the LEC housing each bridge unit.

34. The method of claim 14, wherein the assigning of new call-in numbers in said assigning step comprises allocating to each bridge unit a specific percentage of the new hosts by assigning to the hosts call-in numbers specific to a particular bridge unit.

35. The method of claim 14, wherein the assigning of new call-in numbers in said assigning step occurs through a website.

36. The method of claim 35, wherein the website is self-service on the part of the customer.

37. The method of claim 14, wherein the call-in number and access code have a finite lifetime of host use.

38. The method of claim 37, wherein the call-in number and access code lifetime set to a time period by balancing one or more factors selected from the group consisting of need to adjust the percent total hosts allocated to each bridge unit and host satisfaction with the system.

39. The method of claim 38, wherein said time period is selected from the group consisting of at least about 30 days, at least about 60 days, at least about 90 days and at least about 120 days.
